(19) United States
(12) Patent Application Publication
(10) Pub. No.: US 2021/0274864 A1
(43) Pub. Date: Sep. 9, 2021

(54) MASK

(71) Applicant: 3M INNOVATIVE PROPERTIES COMPANY, St. Paul, MN (US)

(72) Inventors: Jin-Ho Lee, Seoul (KR); Jungchul Moon, Gyeonggi-do (KR); Jung Han Kim, Gyeonggi-do (KR)

(21) Appl. No.: 17/272,953

(22) PCT Filed: Aug. 28, 2019
(86) PCT No.: PCT/IB2019/057261

§ 371 Date: Mar. 3, 2021

(30) Foreign Application Priority Data
Sep. 4, 2018 (KR) 10-2018-0105548

(51) Int. Cl. A41D 13/11

(52) U.S. Cl. CPC A41D 13/1161; A41D 13/1146

(57) ABSTRACT

A mask according to an embodiment of the present disclosure includes: a filtering structure configured to perform an air filtering function; a buckle portion coupled to the filtering structure; and a strap connected to the buckle portion and worn on a body of a user, wherein the buckle portion includes: a body coupled to the filtering structure and having openings formed on both sides thereof; and a fixing piece having one side hinged to a sidewall of the opening and gripping the strap, wherein the strap is inserted between a side surface of the fixing piece and a side-wall of the opening to surround at least a part of an outer surface of the fixing piece, and slidably moves in one direction or both directions in the buckle portion selectively according to a shape of surrounding the fixing piece.

### TECHNICAL FIELD

The present disclosure relates to a mask which can have a length of a strap adjusted.

### BACKGROUND ART

Masks are worn to prevent dust, small particles, odour, or gas from entering the mouth or the nose of the human body, and in particular, the use of masks is required in industrial settings for the sake of workers' health and safety.

Due to the characteristic of the mask of being required to be worn several times a day, masks easy to wear are produced. For example, a mask which is worn in such a manner that elastic straps are connected to both sides of a cover covering the mouth and the nose, and the elastic straps are positioned on the ears or the back of the head to make the cover come into contact with the face was suggested.

The cover is normally provided with a filtering structure performing an air filtering function, and fixing structures are disposed on both sides of the cover to fix the straps, and the mask is worn on a user with the straps being coupled to the fixing structures.

In the case of the mask worn on the user by using the straps described above, the user may adjust the length of the strap to make the mask fit user's face.

### SUMMARY

### Technical Problem

In the case of related-art masks, it is not easy to adjust length of the strap and users are not comfortable when wearing the masks. Even after the mask is worn, in some instances the mask is not in close contact with user's face and thus there is a problem that air filtering efficiency is reduced.

Therefore, an object of the present disclosure is to provide a mask which can have a length of a strap easily adjusted.

### Technical Solution

A mask according to an embodiment of the present disclosure may include: a filtering structure configured to perform an air filtering function; a buckle portion coupled to the filtering structure; and a strap connected to the buckle portion and worn on a body of a user. The buckle portion may include: a body coupled to the filtering structure and having openings formed on both sides thereof; and a fixing piece having one side hinged to a sidewall of the opening and gripping the strap. The strap may be inserted between a side surface of the fixing piece and a sidewall of the opening to surround at least a part of an outer surface of the fixing piece, and slidably move in one direction or both directions in the buckle portion selectively according to a shape of surrounding the fixing piece.

### Advantageous Effects

The mask according to an embodiment of the disclosure can have the length of the strap easily adjusted.

### BRIEF DESCRIPTION OF THE DRAWINGS

FIG. 1 is a schematic perspective view of a mask according to an embodiment of the present disclosure;

FIG. 2 is a schematic perspective view of a buckle portion according to an embodiment of the present disclosure;

FIG. 3 is a schematic bottom perspective view of the buckle portion according to an embodiment of the present disclosure;

FIG. 4 is a schematic top view of the buckle portion according to an embodiment of the present disclosure;

FIG. 5 is a schematic cross-sectional view taken along the line A-A′ of FIG. 2;

FIG. 6 is a schematic cross-sectional view taken along the line B-B′ of FIG. 2;

FIG. 7 is a schematic cross-sectional view illustrating the strap which is disposed to be slidably movable in the buckle portion according to an embodiment of the present disclosure;

FIG. 8 is a schematic cross-sectional view illustrating the strap which is fixedly disposed in the buckle portion according to an embodiment of the present disclosure; and

FIG. 9 is a schematic cross-sectional view of a buckle portion according to another embodiment of the present disclosure.

### DETAILED DESCRIPTION

Prior to describing the present disclosure in detail, it is noted that terms or words used in the detailed description and the claims described hereinbelow should not be interpreted as having ordinary or dictionary meanings, and should be interpreted as meanings and concepts conforming to the technical concept of the present disclosure, based on the principle that the inventors can appropriately define the concepts of terms to explain their own invention in the best method. Accordingly, the embodiments described in the detailed description and the configurations illustrated in the drawings are merely the most preferred embodiments, and do not represent all technical concepts of the present disclosure. Therefore, it should be understood that there may be various equivalents and variations substituting these at the time of filing of the present application.

Hereinafter, preferred embodiments of the present disclosure will be described in detail with reference to the accompanying drawings. It should be noted that the same elements are indicated by the same reference numerals in the accompanying drawings. In addition, well-known functions or constructions are not described in detail since they would obscure the main features of the present disclosure in unnecessary detail. For the same reason, some element may be exaggerated, omitted or schematically illustrated in the drawings, and the size of each element does not entirely reflect a real size.

In addition, throughout the description, the expressions “upper portion,” “lower portion,” and the like are described with reference to illustrations in the drawings, and it is to be noted that these may be expressed differently when the orientation of a corresponding object is changed.

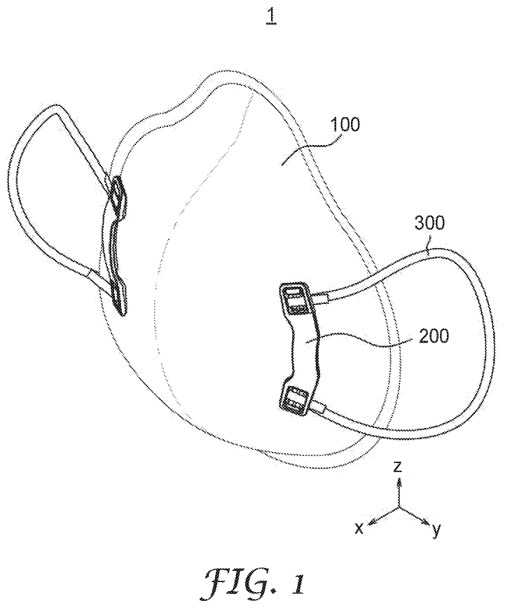

FIG. 1 is a schematic perspective view of a mask 1 according to an embodiment of the present disclosure. Referring to FIG. 1, the mask 1 of the present disclosure may include a filtering structure 100, a buckle portion 200, and a strap 300.

The filtering structure 100 is a member for filtering air by removing impurities of air passing through the filtering structure 100, and may be manufactured in a cup-like shape to be in close contact with user's face and to cover user's nose and mouth. The filtering structure 100 may include a filter for filtering air, and for example, may be provided with a multi-layer having a plurality of sheets including one or more filtering layers and stacked one on another. However, the shape of the filtering structure 100 is not limited to the suggested embodiment and may be changed in various forms normally used in the relevant art.

The buckle portion 200 may be coupled to the filtering structure 100. The buckle portion 200 may be provided on the filtering structure 100 to fix the strap 300, and for example, may be provided on one side surface of the filtering structure 100 and on the other side surface opposite to the one side surface, respectively.

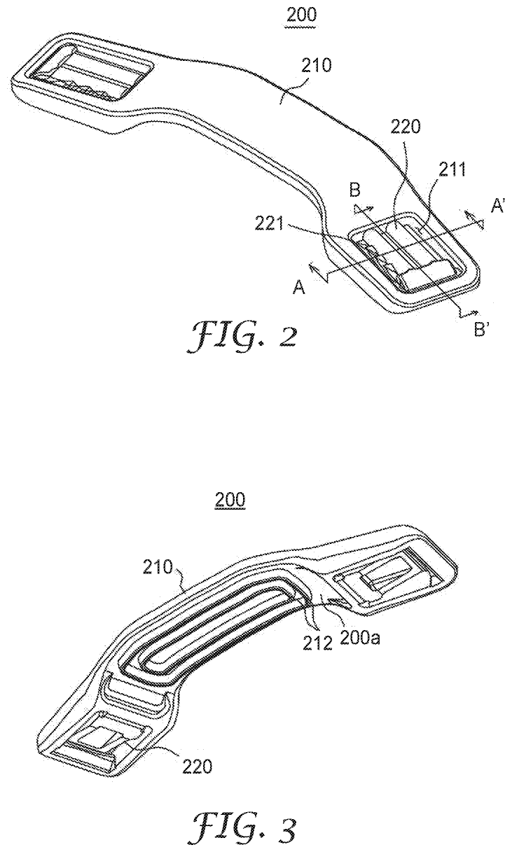

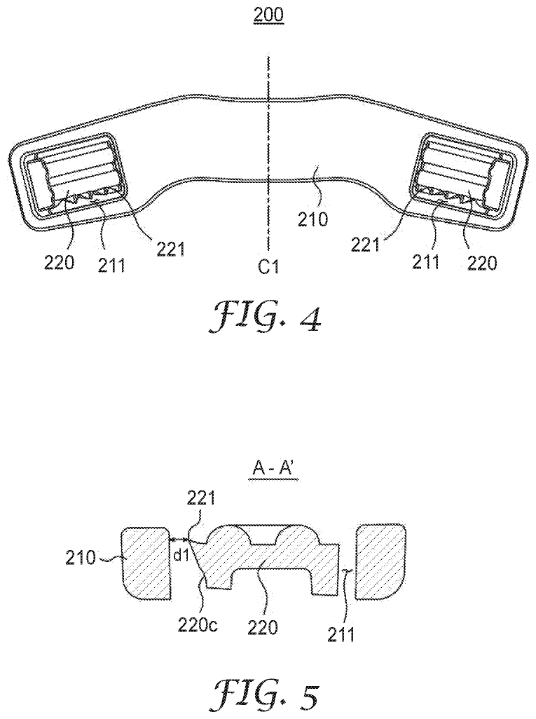

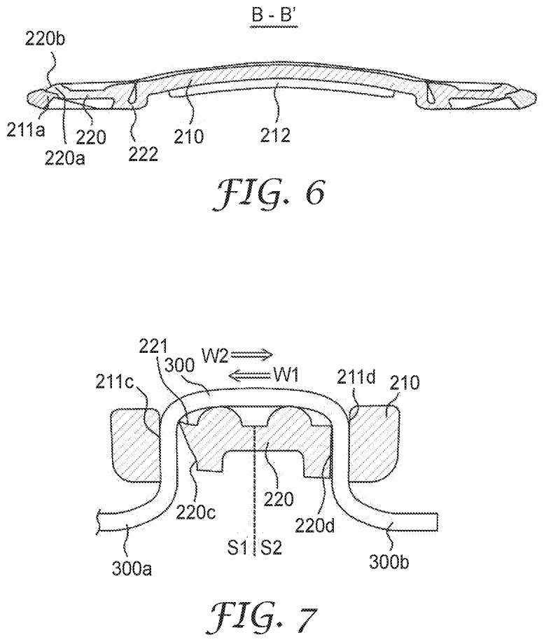

Hereinafter, a detailed configuration of the buckle portion 200 provided on the mask 1 according to an embodiment will be described with reference to FIGS. 2 to 6. FIG. 2 is a schematic perspective view of the buckle portion according to an embodiment, FIG. 3 is a schematic bottom perspective view of the buckle portion according to an embodiment, FIG. 4 is a schematic top view of the buckle portion according to an embodiment, FIG. 5 is a schematic cross-sectional view taken along the line A-A′ of FIG. 2, and FIG. 6 is a schematic cross-sectional view taken along the line B-B′ of FIG. 2.

Referring to FIGS. 2 to 6, the buckle portion 200 may fix the strap 300 to the filtering structure 100 to be able to have the length of the strap 300 adjusted. For example, the buckle portion 200 may fix the strap 300 to the filtering structure 100 to be able to have the strap 300 move in one direction or both directions, and accordingly, a user can easily adjust the length of the strap 300. A detailed configuration for adjusting the length of the strap 300 through the buckle portion 200 will be described below.

The buckle portion 200 may be formed by injection molding, and may include a body 210 coupled to the filtering structure 100 and having openings 211 formed on both sides thereof, and a fixing piece 220 having one side hinged to a sidewall of the opening 211 and griping the strap 300. Herein, the body 210 and the fixing piece 220 may be integrally formed with each other by injection molding or may be separately formed by injection molding and coupled to each other.

The body 210 may have one side and the other side symmetrical to each other with reference to a center line C1 of the body 210. A bonding portion 212 for coupling to the filtering structure 100 may protrude from one surface of the body 210, for example, a rear surface 200a of the body 210 facing the filtering structure 100. The bonding portion 212 may be bonded to a front surface of the filtering structure 100 by thermal bonding or ultrasonic bonding, such that the buckle portion 200 is coupled to the filtering structure 100. However, the buckle portion 200 may be bonded to the filtering structure 100 by using an adhesive, or may be sewed on the filtering structure 100.

The openings 211 may be formed on one side and the other side of the body 210 to penetrate through the body 210, and one side of the fixing piece 220 may be connected to the sidewall of the opening 211.

A saw-toothed portion 221 may protrude from a side surface of the fixing piece 220 to be inclined in one direction. The saw-toothed portion 221 is inclined in one direction as described above, such that the fixing piece 220 can grip the strap 300 to be able to have the length of the strap 300 adjusted.

Referring to FIG. 5, the saw-toothed portion 221 may be formed on any one of the side surfaces of the fixing piece 220 to be inclined forward, for example. For example, the saw-toothed portion 221 may protrude from a side surface 220c of one side of the fixing piece 220, and in this case, the saw-toothed portion 221 may be inclined forward, that is, in the x-axis direction with reference to FIG. 1.

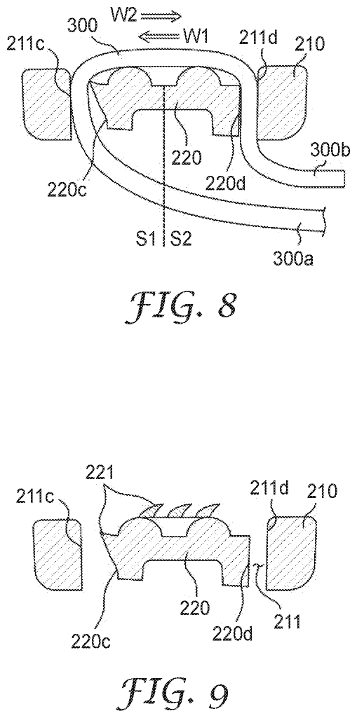

In addition, the saw-toothed portion 221 may be formed on a front surface of the fixing piece 220. In other words, referring to FIG. 9, the saw-toothed portion 221 may protrude from the front surface of the fixing piece 220, and in this case, the saw-toothed portion 221 may be inclined backward, that is, in the opposite direction of the x-axis direction with reference to FIG. 1. As will be described below, the saw-toothed portion 221 is inclined, such that the buckle portion 200 can fix the strap 300 to be able to have the strap 300 slidably move in one direction or both directions.

A distance d1 between an end of the saw-toothed portion 221 formed on the side surface of the fixing piece 220 and the sidewall of the opening 211 may be shorter than a thickness of the strap 300. Accordingly, when the strap 300 is inserted between the fixing piece 220 and the sidewall of the opening 211, the strap 300 may be fixed, being pressed by the saw-toothed portion 221.

One side of the fixing piece 220 may be coupled to the opening 211 and may be restricted thereby, and the other side of the fixing piece 220 may be provided as a free end 220a. Herein, an inclined portion 220b may be formed on a front surface of the free end 220a of the other side of the fixing piece 220 to be inclined to reduce the thickness of the free end 220a toward the outside.

In this case, only a part of the full width of the fixing piece 220 may be connected with the opening 211, such that, when a force is applied to the fixing piece 220, a connection portion 222 of one side of the fixing piece 220 connected to a sidewall of the opening 211 is stretched and is rotated.

A seating portion 211a may protrude from a sidewall of the opening 211 facing the free end 220a of the other side of the fixing piece 220 to have the free end 220a seated thereon. To achieve this, the free end 220a of the fixing piece 220 and the seating portion 211a may be disposed to overlap each other at least in part in a forward and backward direction.

The strap 300 may be connected to the fixing piece 220. For example, the strap 300 may be connected to the fixing piece 220 to have one side inserted between the fixing piece 220 and the opening 211 which are disposed on one side of the buckle portion 200, and to have the other side inserted between the fixing piece 220 and the opening 211 which are disposed on the other side of the buckle portion 200.

The strap 300 may come into contact with the fixing piece 220 in such a shape that the strap 300 is inserted between the side surface of the fixing piece 220 and the sidewall of the opening 211 and surrounds at least a part of the outer surface of the fixing piece 220. In this case, according to a shape of the strap 300 surrounding the fixing piece 220, the strap 300 may be selectively slidable in one direction or both directions in the buckle portion 200. Hereinafter, referring further to FIGS. 7 and 8, a configuration in which the strap 300 slidably moves in one direction or both directions according to a shape of the strap 300 surrounding the fixing piece 220 will be described.

FIG. 7 is a schematic cross-sectional view illustrating the strap which is disposed to be slidably movable in both directions in the buckle portion according to an embodiment, and FIG. 8 is a schematic cross-sectional view illustrating the strap which is disposed to be slidably movable in one direction in the buckle portion according to an embodiment.

Referring to FIG. 7, when both ends of the strap 300 are positioned opposite to each other with reference to the fixing piece 220, the strap 300 may be slidably movable in both directions in the buckle portion 200. For example, in the case where one portion 300a of the strap 300 passing between the side surface 220c of one side of the fixing piece 220 and the sidewall 211c of the opening 211 facing each other, and the other portion 300b of the strap 300 passing through the side surface 220d of the other side of the fixing piece 220 and the sidewall 211d of the opening 211 facing each other are positioned on one side s1 and the other side s2, respectively, with reference to the fixing piece 220, the strap 300 may slidably move in a first direction w1 when one portion 300a of the strap 300 is pulled, and the strap 300 may slidably move in a second direction w2 when the other portion 300b of the strap 300 is pulled. That is, when both sides of the strap 300 are positioned opposite to each other with reference to the fixing piece 220, the strap 300 can slidably move in both directions without being caught by the saw-toothed piece 221 of the fixing piece 220. Therefore, the user can adjust the length of the strap 300 to have an appropriate length by moving the strap 300 in both directions before wearing the mask.

Referring to FIG. 8, when both ends of the strap 300 are positioned in the same direction with reference to the fixing piece 220, the strap 300 may be slidably movable in one direction in the buckle portion 200. For example, in the case where one portion 300a of the strap 300 passing between the side surface 220c of one side of the fixing piece 220 and the sidewall 211c of the opening 211 facing each other, and the other portion 300b of the strap 300 passing through the side surface 220d of the other side of the fixing piece 220 and the sidewall 211d of the opening 211 facing each other are positioned on the same side with reference to the fixing piece 220, the strap 300 may slidably move in the second direction w2 when the other portion 300b of the strap 300 is pulled, but the strap 300 may not slidably move and may be fixed when one portion 300a of the strap 300 is pulled. That is, due to the mechanical shape of the saw-toothed portion 221, the strap 300 may easily move in the second direction w2, but may be caught by the saw-toothed portion 221 in the first direction w1 and the movement of the strap 300 may be restricted.

Herein, one portion 300a of the strap 300 may refer to a portion that is worn on user's ear. Accordingly, when the user hangs the strap 300 on ears to wear the mask 1, one portion 300a and the other portion 33b of the strap 300 are positioned on the same position. Therefore, the user can reduce the length of the strap 300 by pulling the other portion 300b of the strap 300 while hanging the strap 300 on user's ear, but the length of the strap 300 does not increase even when one portion 300a of the strap 300 is pulled in the opposite direction.

As a result, the user may position both sides of the strap 300 on the opposite sides and may primarily adjust the length of the strap 300 before wearing the mask 1, and may adjust the length of the strap 300 more tightly by pulling the other portion 300b of the strap 300 after wearing the mask 1. As described above, the fixing piece 220 provided with the saw-toothed portion 221 is formed on the buckle portion 200, such that the mask 1 according to an embodiment can have the length of the strap 300 easily adjusted.

The following is a list of embodiments of present disclosure.

Item 1 is a mask including: a filtering structure configured to perform an air filtering function; a buckle portion coupled to the filtering structure; and a strap connected to the buckle portion and worn on a body of a user, wherein the buckle portion includes: a body coupled to the filtering structure and having openings formed on both sides thereof; and a fixing piece having one side hinged to a sidewall of the opening and gripping the strap, wherein the strap is inserted between a side surface of the fixing piece and a sidewall of the opening to surround at least a part of an outer surface of the fixing piece, and slidably moves in one direction or both directions in the buckle portion selectively according to a shape of surrounding the fixing piece.

Item 2 is the mask, wherein, when one portion of the strap passing between a side surface of one side of the fixing piece and a sidewall of the opening facing each other, and the other portion of the strap passing between a side surface of the other side of the fixing piece and a sidewall of the opening facing each other are positioned on one side and the other side, respectively, with reference to the fixing piece, the strap is slidably movable in both directions in the buckle portion, and wherein, when one portion of the strap passing between the side surface of one side of the fixing piece and the sidewall of the opening facing each other, and the other portion of the strap passing between the side surface of the other side of the fixing piece and the sidewall of the opening facing each other are positioned on a same side with reference to the fixing piece, the strap is slidably movable in one direction in the buckle portion.

Item 3 is the mask, wherein a saw-toothed portion protrudes from an outer surface of the fixing piece.

Item 4 is the mask, wherein the saw-toothed portion is inclined forward from at least one side surface of a side surface of one side of the fixing piece and a side surface of the other side of the fixing piece.

Item 5 is the mask, wherein the saw-toothed portion is inclined backward from an outer surface of the fixing piece.

Item 6 is the mask, wherein a distance between an end of the saw-toothed portion and the sidewall of the opening is shorter than a thickness of the strap.

Item 7 is the mask, wherein a bonding portion protrudes from one surface of the body facing the filtering structure to be bonded to the filtering structure by ultrasonic bonding.

Item 8 is the mask, wherein one side of the strap is inserted between the fixing piece and the opening which are disposed on one side of the buckle portion, and the other side of the strap is inserted between the fixing piece and the opening which are disposed on the other side of the buckle portion.

Item 9 is the mask, wherein a seating portion protrudes from a sidewall of the opening facing a free end of the other side of the fixing piece to have the free end seated thereon.

Item 10 is the mask, wherein an inclined portion is formed on a front surface of the free end to make a thickness of the free end gradually reduced toward the outside.

Item 11 is the mask, wherein the buckle portion and the strap are provided on one side surface of the filtering structure and the other side surface opposite to the one side surface.

Item 12 is the mask, wherein the buckle portion is integrally formed by injection molding.

While the configuration and features of the present disclosure have been described with reference to the embodiments of the present disclosure, the present disclosure is not limited thereto, and it is obvious to those skilled in the art that various changes or modifications can be made within the spirit and scope of the present disclosure, and accordingly, it is noted that such changes or modifications belong to the appended claims.

What is claimed is:

1. A mask comprising:
a filtering structure configured to perform an air filtering function;
a buckle portion coupled to the filtering structure; and
a strap connected to the buckle portion and worn on a body of a user,
wherein the buckle portion comprises:
a body coupled to the filtering structure and having openings formed on both sides thereof; and
a fixing piece having one side hinged to a sidewall of the opening and gripping the strap,
wherein the strap is inserted between a side surface of the fixing piece and a sidewall of the opening to surround at least a part of an outer surface of the fixing piece, and slidably moves in one direction or both directions selectively according to a shape of surrounding the fixing piece.

2. The mask of claim 1, wherein, when one portion of the strap passing between a side surface of one side of the fixing piece and a sidewall of the opening facing each other, and the other portion of the strap passing between a side surface of the other side of the fixing piece and a sidewall of the opening facing each other are positioned on one side and the other side, respectively, with reference to the fixing piece, the strap is slidably movable in one direction in the buckle portion, and
wherein, when one portion of the strap passing between the side surface of one side of the fixing piece and the sidewall of the opening facing each other, and the other portion of the strap passing between the side surface of the other side of the fixing piece and the sidewall of the opening facing each other are positioned on a same side with reference to the fixing piece, the strap is slidably movable in both directions in the buckle portion.

3. The mask of claim 1, wherein a saw-toothed portion protrudes from an outer surface of the fixing piece.

4. The mask of claim 3, wherein the saw-toothed portion is inclined forward from at least one side surface of a side surface of one side of the fixing piece and a side surface of the other side of the fixing piece.

5. The mask of claim 3, wherein the saw-toothed portion is inclined backward from a front surface of the fixing piece.

6. The mask of claim 3, wherein a distance between an end of the saw-toothed portion and the sidewall of the opening is shorter than a thickness of the strap.

7. The mask of claim 1, wherein a bonding portion protrudes from one surface of the body facing the filtering structure to be bonded to the filtering structure by ultrasonic bonding.

8. The mask of claim 1, wherein one side of the strap is inserted between the fixing piece and the opening which are disposed on one side of the buckle portion, and
wherein the other side of the strap is inserted between the fixing piece and the opening which are disposed on the other side of the buckle portion.

9. The mask of claim 1, wherein a seating portion protrudes from a sidewall of the opening facing a free end of the other side of the fixing piece to have the free end seated thereon.

10. The mask of claim 9, wherein an inclined portion is formed on a front surface of the free end to make a thickness of the free end gradually reduced toward the outside.

11. The mask of claim 1, wherein the buckle portion and the strap are provided on one side surface of the filtering structure and the other side surface opposite to the one side surface.

12. The mask of claim 1, wherein the buckle portion is integrally formed by injection molding.
